(19) United States
(12) Patent Application Publication
(10) Pub. No.: US 2018/0167650 A1
(43) Pub. Date: Jun. 14, 2018

(54) SYSTEM AND METHOD FOR TRANSMITTING VIDEO DATA FROM A SERVER TO A CLIENT

(71) Applicant: Siemens Aktiengesellschaft, München (DE)

(72) Inventors: Andreas Hutter, München (DE); Norbert Oertel, Gotha (DE)

(21) Appl. No.: 15/573,099

(22) PCT Filed: May 11, 2016
(86) PCT No.: PCT/EP2016/060483

§ 371 Date: Nov. 9, 2017

(30) Foreign Application Priority Data
May 12, 2015 (DE) 10 2015 208 740.9

(51) Int. Cl. H04N 21/2343; H04N 21/654; H04N 21/2187

(52) U.S. Cl. CPC H04N 21/2343; H04N 21/2187; H04N 21/654

(57) ABSTRACT

The invention relates to a system for transmitting video data from a server to a client. The system has a first coding unit, which is designed to transmit video data of a first quality from the server to the client in the form of a livestream, and a second coding unit, which is designed to store the video data in a second quality in a storage unit (13) and to transmit the coded video data in the second quality from the storage unit (13) to the client (2) in response to a request signal from the client (2), wherein the second quality is greater than the first quality. The proposed system allows video data to be transmitted from a medical environment, for example an operating room, to an external expert via a network. The video data in the form of a livestream is provided in a low quality and can additionally be provided in a high quality upon request by the expert. The invention further relates to a method for transmitting video data from a server to a client.

### CROSS-REFERENCE TO RELATED APPLICATIONS

This application claims priority to PCT Application No. PCT/EP2016/060483, having a filing date of May 11, 2016, based off of German application No. DE 102015208740.9 having a filing date of May 12, 2015, the entire contents of both of which are hereby incorporated by reference.

### FIELD OF TECHNOLOGY

The following relates to a system for transmitting video data from a server to a client, in particular medical video data that are transmitted for diagnosis purposes from a medical environment to an external client. Moreover, embodiments of the present invention relate to a corresponding method for transmitting video data from a server to a client.

### BACKGROUND

In the medical sphere, e.g. when typing cancerous tissue during an operation in the operating theater using microscopy pictures, an image-based remote collaboration application is desirable. In this context, it is necessary to make safe decisions taking into consideration the strain on the patient and the costs. It must be remembered in this case that it costs time and money to fetch experts, such as e.g. pathologists, to the operating theater for the microscopic determination of tissue types. The same applies when tissue samples are sent to a laboratory for determination.

In order to allow a remote diagnosis by an expert, it is necessary to transmit pictures, for example video data, to said expert from the medical sphere. To allow a reliable diagnosis, however, these video data need to be available to the expert quickly and in a high quality. In order to ensure fast transmission, however, lossy compression methods are frequently used, which do not allow adequate quality to be ensured.

### SUMMARY

An aspect relates to allowing fast provision of video data in high quality.

Accordingly, a system for transmitting video data from a server to a client is proposed. The system has a first encoding unit that is set up to transmit video data from the server with a first quality to the client as a live stream, and a second encoding unit that is set up to store the video data in a second quality in a memory unit and, in response to a request signal from the client, to transmit the encoded video data in the second quality from the memory unit to the client, the second quality being higher than the first quality.

The respective unit, for example encoding unit, may be implemented in hardware and/or in software. In the case of a hardware implementation, the respective unit may be in the form of an apparatus or in the form of part of an apparatus, for example in the form of a computer or in the form of a microprocessor or in the form of a control computer of a vehicle. In the case of a software implementation, the respective unit may be in the form of a computer program product (non-transitory computer readable storage medium having instructions, which when executed by a processor, perform actions), in the form of a function, in the form of a routine, in the form of part of a program code or in the form of an executable object.

The proposed system allows video data to be sent to experts who are remote in space and/or time for diagnosis. In this case, the first encoding unit makes certain of a live stream transmission. This can be effected in a low quality (first quality) for the video data, e.g. using compression methods such as e.g. H.264 or HEVC. Additionally, if requested, i.e. on request by means of an http request, for example, the video data can be transmitted in a high quality (second quality) from the client to the server with details encoded in a URL in regard to the requested video. The transmission of the video data in the high quality can also be effected only for a particular portion of the video data, such as sequences of particular interest, for example. The details in this regard can be encoded e.g. in a URL that is transmitted in the request as well, and can comprise e.g. further information, such as which video stream, when multiple video streams are present, is desired or which period of the video data is needed, for example.

In this manner, image information, i.e. video data, from a medical sphere or environment, e.g. an operating theater, can be made available online, i.e. live and with a short delay, to a client, for example a remote expert. As a result, the latter may be interactively (in a controlling capacity) in contact with the operator or the microscopic equipment, i.e. apparatuses or the like from the medical sphere.

The second encoding unit can store the video data in the second quality in the memory unit, which may be a database or a buffer store, e.g. a ring memory, for example. Since the video data in the second, higher or high, quality need to be sent to the client only on request, they can thus be stored in already encoded form. In response to the request signal from the client, the encoded video data in the second quality, e.g. the requested sections or sequences of the video data, can then be transmitted from the memory unit to the client. In this manner, it is possible to react to requests in regard to video pictures from times in the past.

The video data in the second quality can be provided in sections, for example. In this manner, it is not necessary for all the video data to be transmitted in the high quality, but rather only the requested sections that are of interest to the external expert.

The server can be understood in this context to mean the server-end elements, i.e. all the elements that are needed in connection with the transmission of the video data from the medical sphere. The client can be understood in this context to mean an external apparatus to which the server transmits video data for display. This external apparatus can be used by an expert.

Video data are understood in this context to mean a signal that includes video data.

According to one embodiment, the first quality indicates a first resolution of the video data and/or first encoding parameters of the video data and the second quality indicates a second resolution of the video data and/or second encoding parameters.

In the first quality, the video data may be relatively highly compressed in order to allow fast transmission. As such, even in the case of a limited communication bandwidth, i.e. a low bandwidth of the network via which the video data are sent from the server to the client, it is possible for fast transmission to be ensured.

Since the expert also needs promptly and quickly selectable image information in high (diagnosis-compatible) quality, however, the video data can, in response to a request signal from the client, i.e. if the client so requests, be provided in the second, higher quality. In this case, the metadata and event information associated with the video data can also be made available for said video data.

By way of example, quality can be understood to mean a resolution of the video data, the second resolution being higher than the first resolution. The resolution may be a spatial resolution and/or a temporal resolution, i.e. the frame repetition rate. The quality can also be determined by different encoding parameters, e.g. the quantization.

According to a further embodiment, the stored encoded video data include an index for accessing the content of the video data.

To simplify access to particular sections or sequences of the video data, the video data can include an index. This index can index the sections of the video data, for example using the event information or temporally.

According to a further embodiment, the first encoding unit is set up to receive the video data and to encode them in the first quality.

To encode the video data in the first quality, it is possible to use compression methods, such as e.g. H.264/AVC or H.265/HEVC. In this manner, the volume of data in the video data can be reduced.

According to a further embodiment, the first encoding unit is set up to add metadata to the video data during the encoding of the video data, wherein the metadata include information about the content of the video data.

Metadata may, in this context, be information that results from automated analyses of the video data, for example. If the video data are microscopy or macroscopy video images, for example, they can already be analyzed in automated fashion at the server end, i.e. in the medical sphere, such as an operating theater, and this analysis information can be integrated into the transmitted video data. In this case, the metadata can be transmitted in a separate stream, may be embedded in the video stream at syntactic level, e.g. as H.264 or H.265 SEI messages, and/or can be firmly linked to the video content as an overlay before the encoding.

According to a further embodiment, the first encoding unit is set up to add event information to the video data during the encoding of the video data.

In this case, the event information can likewise be transmitted in a separate stream, may be embedded in the video stream at syntactic level, e.g. as H.264 or H.265 SEI messages, and/or can be firmly linked to the video content as an overlay before the encoding.

Event information may be information that points to a server-end event, for example. Such events can be consciously caused at a server end in order to integrate them into the video data.

According to a further embodiment, the event information points to particular sequences in the video data.

Intentionally caused events can point to particular sequences in the video data, for example.

According to a further embodiment, the second encoding unit is set up to receive the video data, to encode said video data in the second quality and to store them in the memory unit, and/or to receive the metadata and/or event information and to store them in the memory unit.

In this case, the metadata and event information are not branded into the image material as an overlay before the encoding. When the video material, i.e. the video data, is transmitted to the client on request, this information can be transmitted as well on request. A decoding unit of the client can then present this information in a suitable manner, e.g. can present it as an overlay over the video after decoding.

Although the second encoding can likewise perform a compression method, a higher quality of the video data is achieved at any rate.

According to a further embodiment, the system has a first decoding unit that is set up to decode the video data with the first quality and to display them on a display apparatus, and a second decoding unit that is set up to request the video data in the second quality, to decode said video data and to display them on the display apparatus.

At the client end, the video data can be decoded by decoding units and presented on a display apparatus. In this case, the second decoding unit becomes active only if the video data have been requested and transmitted to the second decoding unit in the second quality.

According to a further embodiment, the memory unit is set up to transmit the video data to the second decoding unit in the second quality based on an available bandwidth.

According to this embodiment, the video data are transmitted in the second quality taking into consideration the available bandwidth. This means that the video data are transmitted in the second quality if sufficient bandwidth is available, for example. In this manner, the transmission of the video data in the first quality, for which low latency is important, is not influenced.

In this case, an available bandwidth can be ascertained at the server end. The second decoding unit can retrieve a section of the video data in the second quality, for example on the basis of a starting and ending time. The available bandwidth with which these data are sent from the server to the client can then be determined at the server end from the total available bandwidth minus the bandwidth that is needed in order to maintain the live stream, i.e. the transmission of the video data in the first quality. When the video data are transmitted in the first quality, the first quality could be reduced further in order to reduce the bandwidth requirement further and to provide more bandwidth for transmitting the requested video data in the second quality.

According to a further embodiment, the second decoding unit is set up to store the video data and/or the metadata and/or the event information in the second quality in a memory apparatus at the client end.

By virtue of the video data and/or the associated metadata and event information in the second quality being stored at the client end, these video data are available for renewed playback and display.

All or some of the data stored in the memory unit at the server end and the memory apparatus at the client end can be archived in a PACS (Picture Archiving and Communication System) system. This PACS system may also be cloud-based.

According to a further embodiment, the second decoding unit is set up to display the video data in the second quality on the display apparatus with overlaid information, wherein the information is metadata and/or event information.

During the decoding of the video data, the second decoding unit can extract the metadata and/or event information possibly included in said video data. During the display on the display apparatus, said metadata and/or event information can likewise be displayed in addition to the video data themselves.

According to a further embodiment, the system has a control unit that is set up to receive a user input in response to the displayed video data and to transmit the user input as a control signal to the server.

In this manner, control signals can be transmitted to an actuator in an operating theater from the client end, i.e. by the external expert, for example. Such actuators can control e.g. a positioning of a microscope.

According to a further embodiment, the system has a mixing unit that is set up to mix multiple local video streams to form a common local video stream and to provide the common local video stream as the video data to the first encoding unit.

The video data can include multiple video streams, for example from different cameras, which are combined by the mixing unit to form a signal. During the decoding, said video streams can be separated again and displayed as separate images.

In summary, the proposed system and the different embodiments thereof can achieve the following embodiments and the associated advantages:
Realtime encoding by the encoding units in high quality for the video sources involved (microscopy, macroscopy).
Local recording of the encoded streams from the video sources involved, of the metadata from the automated analysis of the videos and of events that can be triggered e.g. by foot switches or similar input devices and can be used for annotating the recorded data. In this case, it is additionally possible for information regarding the temporal synchronization of the video streams, metadata and events among one another to be stored, and for an index for accessing (based on time, metadata and events) the recorded data to be generated.
Adaptive realtime encoding of the video sources involved (microscopy, macroscopy) for the live streaming from the operating theater to the connected expert. In this case, videos can be selectively overlaid with metadata or information regarding events, and multiple video streams can be mixed locally to form one stream. The necessary control signals therefor (encoder control, overlay, mixing) may firstly be provided by measured values (e.g. instantaneous bandwidth between expert and operating theater for controlling the encoder), or can be generated locally or remotely by a user interface. In the latter case, these signals are transmitted via the network.
Streaming of the encoded live video signal(s) from the operating theater to the expert at low latency.
Display of the live video signals to the expert and/or in the operating theater, with a selection and configuration option for the metadata overlay and the local presentation of the video signals (mixing).
Access to the information regarding recorded, high-quality video signals, the metadata and events from the expert's end, download of portions of the recording of these data and storage of the downloaded data at the expert's end. The download of the high-quality video pictures can be effected in the background with priority given to the data rate for the live streams.
Reproduction of the high-quality video signals downloaded and locally stored at the expert's end with selective overlay of the video signals with metadata and event overlays. The reproduction can already be effected even though the requested data are not yet downloaded completely (progressive download).
Transmission of control signals from the expert's end to the operating theater for controlling actuators, e.g. positioning the microscope.
Portions of the data from the recording at the operating theater end and at the expert's end can be archived in a PACS system. This PACS system may also be cloud-based.
To be able to establish the necessary network connectivity between operating theater and expert, it is possible for a, possibly cloud-based, relay to be used.

According to a further aspect, a method for transmitting video data from a server to a client is proposed. The method has the following steps: transmitting video data from the server with a first quality to the client as a live stream, and transmitting the video data in a second quality to the client in response to a request signal from the client, the second quality being higher than the first quality.

In addition, a computer program product is proposed that prompts the performance of the method as explained above on a program-controlled device.

A computer program product, such as e.g. a computer program means, can be provided or delivered as a storage medium, such as e.g. a memory card, USB stick, CD-ROM, DVD, or in the form of a downloadable file from a server in a network, for example. This can be effected in a wireless communication network, for example, by the transmission of an appropriate file with the computer program product or the computer program means.

The embodiments and features described for the proposed system apply to the proposed method accordingly.

Further possible implementations of embodiments of the invention also comprise not explicitly cited combinations of features or embodiments described above or below for the exemplary embodiments. In this case, a person skilled in the art will also add single aspects as improvements or additions to the respective basic form of embodiments of the invention.

### BRIEF DESCRIPTION

Some of the embodiments will be described in detail, with reference to the following figures, wherein like designations denote like members, wherein:

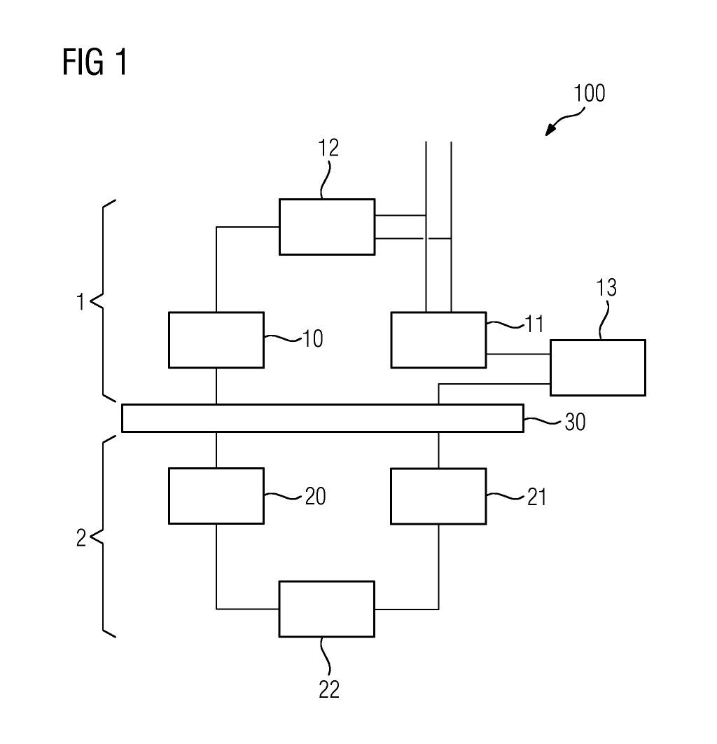

FIG. 1 shows a schematic block diagram of a first embodiment of a system for transmitting video data from a server to a client;

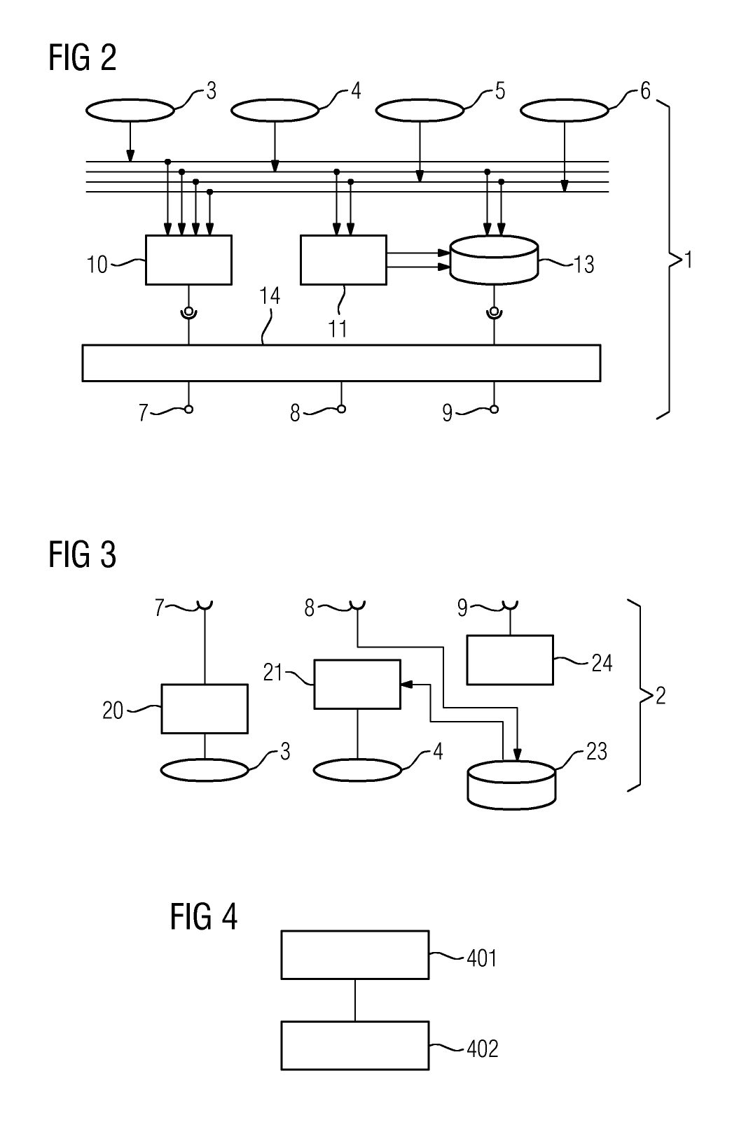

FIG. 2 shows a schematic block diagram of the server-end units of the system from FIG. 1 according to a second embodiment;

FIG. 3 shows a schematic block diagram of the client-end units of the system from FIG. 1 according to the second embodiment; and

FIG. 4 shows a schematic flowchart for a method for transmitting video data from a server to a client.

In the figures, elements that are the same or have the same function have been provided with the same reference symbols, unless indicated otherwise.

### DETAILED DESCRIPTION

FIG. 1 shows a system 100 for transmitting video data from a server 1 to a client 2.

At the server end, a mixing unit 12 is provided that, if present, can combine multiple video streams to form one common video data signal. The mixing unit 12 is optional.

The combined video data signal, also called video data, is provided to a first encoding unit 10. A second encoding unit 11 receives the uncombined video streams.

The first encoding unit 10 transmits the video data from the server 1 with a first quality to the client 2 via a network interface 30. The video data in the first quality are a live stream in this case.

At the client end, the video data in the first quality are received by a first decoding unit 20, are decoded and are displayed on a display apparatus 22, e.g. a monitor.

The second encoding unit 11 stores the video data in a second quality in a memory unit 13. The latter can transmit the video data to the client 2 in response to a request signal from the client 2. The second quality is higher than the first quality in this case.

At the client end, the video data in the second quality are received by a second decoding unit 21 on request, are decoded and are displayed on the display apparatus 22. The second decoding unit 21 can store these video data possibly together with associated metadata and/or event information in a memory apparatus 23 (see FIG. 3).

FIGS. 2 and 3 show a further embodiment of the system 100, with FIG. 2 depicting the server-end section and FIG. 3 depicting the client-end section.

Multiple video streams 3, 4 and also metadata 5 and event information 6 can be combined and provided to the first encoding unit 10 and the second encoding unit 11. According to this embodiment, the first encoding unit 10 encodes the video data 3, 4 together with the metadata 5 and the event information 6 and provides said data and information. By contrast, the second encoding unit 11 only encodes the video data 3, 4 and stores them in the memory unit 13. The metadata 5 and the event information 6 are likewise stored in the memory unit 13.

The server-end area 1 of the system 100 provides an application front end 14 that is used for bandwidth prioritization of the live stream during the transmission, for example. This front end 14 can be used to actuate different interfaces 7, 8 and 9 to the client. The front end 14 is thus used as a network layer between the first encoding unit 10 and the memory unit 13 and also the different interfaces 7, 8 and 9, which are explained below.

Between the server 1 and the client 2, there are different interfaces provided: an interface 7 for the live stream, an interface 8 for accessing the video data in the second quality, also referred to as recording access or memory access, and an interface 9 for control.

The interface 9 for control is used to transmit control signals from the client 2 to the server 1, for example, in order to react to an analysis of the video data. These control signals allow the expert's end to perform control of actuators, e.g. positioning of the microscope, in the operating theater, for example. These control signals can be generated at the client end 2 by the application controller 24.

FIG. 4 shows a method for transmitting video data from a server 1 to a client 2. The method has steps 401 and 402.

In step 401, video data are transmitted from the server 1 with a first quality to the client 2 as a live stream.

In step 402, the video data are transmitted to the client 2 in a second quality in response to a request signal from the client 2, the second quality being higher than the first quality.

Although the present invention has been described on the basis of exemplary embodiments, it is modifiable in a wide variety of ways.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A system for transmitting video data from a server to a client, having:
a first encoding unit that is set up to transmit video data from the server with a first quality to the client as a live stream, and a second encoding unit that is set up to store the video data in a second quality in a memory unite and, in response to a request signal from the client, to transmit the encoded video data in the second quality from the memory unit to the client, the second quality being higher than the first quality.

2. The system as claimed in claim 1, wherein the first quality indicates a first resolution of the video data and/or first encoding parameters of the video data and the second quality indicates a second resolution of the video data and/or second encoding parameters.

3. The system as claimed in claim 1, wherein the stored encoded video data include an index for accessing the content of the video data.

4. The system as claimed in claim 1, wherein the first encoding unit is set up to receive the video data and to encode them in the first quality.

5. The system as claimed in claim 4, wherein the first encoding unit is set up to add metadata to the video data during the encoding of the video data, wherein the metadata include information about the content of the video data.

6. The system as claimed in claim 4, wherein the first encoding unit is set up to add event information to the video data during the encoding of the video data.

7. The system as claimed in claim 6, wherein the event information points to particular sequences in the video data.

8. The system as claimed in claim 1, wherein the second encoding unit is set up to receive the video data, to encode said video data in the second quality and to store them in the memory unit, and/or to receive the metadata and/or event information and to store them in the memory unit.

9. The system as claimed in claim 1, wherein a first decoding unit that is set up to decode the video data with the first quality and to display them on a display apparatus, and a second decoding unit that is set up to request the video data in the second quality, to decode said video data and to display them on the display apparatus.

10. The system as claimed in claim 9, wherein the memory unit set up to transmit the video data to the second decoding unit in the second quality based on an available bandwidth.

11. The system as claimed in claim 9, wherein the second decoding unit is set up to store the video data in the second quality and/or the metadata and/or the event information in a memory apparatus at the client end.

12. The system as claimed in claim 9, wherein the second decoding unit is set up to display the video data in the second quality on the display apparatus with overlaid information, wherein the information is metadata and/or event information.

13. The system as claimed in claim 9, wherein a control unit that is set up to receive a user input in response to the displayed video data and to transmit the user input as a control signal to the server.

14. The system as claimed in claim 1, wherein a mixing unit that is set up to mix multiple local video streams to form a common local video stream and to provide the common local video stream as the video data to the first encoding unit.

15. A method for transmitting video data from a server to a client, involving: transmitting video data from the server with a first quality to the client as a live stream, storing the video data in a second quality and, in response to a request signal from the client, transmitting the video data in the second quality to the client, the second quality being higher than the first quality.

16. A computer program product which performs the method of claim 15, the computer program product on a non-transitory computer readable storage medium having instructions, which when executed by a processor, perform actions.
